(19) United States
(12) Patent Application Publication
(10) Pub. No.: US 2016/0350741 A1
(43) Pub. Date: Dec. 1, 2016

(54) SYSTEM AND METHOD FOR MOBILE DEVICE TRANSACTIONS AT A MERCHANT TERMINAL

(71) Applicant: FEXCO, Killorglin (IE)

(72) Inventor: Paul Reen, Rathmore (IE)

(73) Assignee: FEXCO, Killorglin (IE)

(21) Appl. No.: 14/727,748

(22) Filed: Jun. 1, 2015

(51) Int. Cl. G06Q 20/32; G06Q 20/20

(52) U.S. Cl. CPC G06Q 20/322; G06Q 20/202

(57) ABSTRACT

Mobile device transactions are conducted at a POS terminal using gift card infrastructure. When a mobile device transaction is desired, a pre-designated gift card number is used at the POS terminal, which is recognized during gift card processing as assigned for use with mobile transactions and which results in an open invoice message. At the same time, a mobile device reads a QR code displayed at the POS terminal, in order to generate a transaction request. The open invoice message and transaction request are matched and processed at a mobile transaction processing system.

### BACKGROUND OF THE INVENTION

Use of mobile devices to conduct transactions at merchant locations is gaining acceptance by consumers. Generally, in order to conduct such transactions, a consumer has one or more financial accounts (checking account, credit card account, etc.) linked to a mobile wallet application at the mobile device, permitting the consumer to conduct transactions at point-of-sale (POS) terminals, without having physical debit or credit cards in their possession.

Currently, both a mobile device and a point-of-sale terminal need to be properly provisioned with software to permit mobile device transactions. Mobile devices are often easily provisioned by a user downloading an application and then enrolling his or her accounts using the application. Merchants, on the other hand, need to install more complex software (and sometimes new hardware) at a POS terminal, in order to securely communicate with mobile devices and process mobile device transactions. For smaller merchants, this additional software and hardware can be expensive, and thus some merchants have been slow in adapting their systems to permit mobile device transactions. Having mobile device transactions available at more merchants, regardless of their size and sophistication, would improve customer use and acceptance of mobile device transactions.

### BRIEF SUMMARY OF THE INVENTION

There is provided, in accordance with embodiments of the present invention, a system and method for processing mobile device transactions.

In one embodiment a method for processing a transaction conducted at a point-of-sale (POS) terminal using a mobile device includes receiving, at a mobile transaction processing system, an open invoice message generated by a card processing system, wherein the card processing system generates the open invoice message in response to a card identifier that is received in connection with a mobile device transaction and that has been pre-designated for use with mobile transactions at a POS terminal, and receiving, at the mobile transaction processing system, a mobile transaction request generated by a user of a mobile device at the POS terminal, wherein the mobile transaction request is generated in response to receiving an enabling code at the mobile device, wherein the enabling code is received at the mobile device upon a user initiating a transaction at the POS terminal. The method further includes determining, at the mobile transaction processing system and based upon the open invoice message and the mobile transaction request, that the received open invoice message and the received mobile transaction request are for the same mobile device transaction, and in response to determining that the open invoice message and the transaction request are for the same mobile device transaction, processing that mobile device transaction at the mobile transaction processing system.

A more complete understanding of the present invention may be derived by referring to the detailed description of the invention and to the claims, when considered in connection with the Figures.

### BRIEF DESCRIPTION OF THE DRAWINGS

FIG. 1 is a general block diagram showing an overall payment network where a merchant may accept mobile device transactions without changing its on-location hardware and software.

FIGS. 2A and 2B are general illustrations of messages sent by a POS terminal and by a mobile device when conducting a transaction.

FIG. 3 is a flow diagram of a process implemented within the network of FIG. 1, illustrating the processing of a mobile device transaction using an existing gift card system.

FIG. 4 is a block diagram illustrating an exemplary computer system that may be used to implement various systems seen in FIG. 1.

### DETAILED DESCRIPTION OF THE INVENTION

There are various embodiments and configurations for implementing the present invention. Generally, embodiments enable use of existing infrastructure (such as existing card processing infrastructure) by a merchant for conducting mobile device transactions at a merchant terminal.

In one described embodiment, existing gift card infrastructure (including a gift card backend system maintained by a gift card operating entity) is used to process mobile device transactions at a point-of-sale (POS) terminal. The use of existing gift card infrastructure permits a merchant to conduct mobile device transactions without having to upgrade or change its existing POS terminal and software. However, as will be appreciated from the descriptions of embodiments herein, other existing infrastructure could likewise be used to facilitate mobile device transactions at merchant POS terminals, without upgrading such terminals.

In some embodiments, a physical gift card is associated with a merchant POS terminal (i.e., is available to a clerk at the terminal) and that card is used by the merchant/clerk whenever any customer desires to conduct a mobile device transaction. The gift card has a specific, pre-designated gift card account number or ID that is entered/read at the terminal, with the specific gift card account number indicating to a gift card backend system that the transaction is a mobile device transaction (rather than a gift card transaction to be processed against a gift card account). An open invoice message for a mobile device transaction is generated by the gift card backend system (using transaction information entered at the POS terminal) and sent to a mobile transaction processing system. At the same time, a mobile device user scans an enabling code (such as a QR code—Quick Response code) that may be physically displayed at and is used to identify the merchant/POS terminal. The enabling code results in a transaction request message being transmitted from the mobile device to the mobile transaction processing system, indicating that the user is attempting a mobile device transaction at the identified merchant/terminal. The open invoice message and the transaction request message are used by the mobile transaction processing system to process a mobile device transaction using a financial account associated with the mobile device.

While described embodiments provide a physical gift card for use by a merchant at the POS terminal in order to initiate a mobile transaction, it should be appreciated that the transaction could likewise be initiated with a gift card account number resulting from a scanned bar code or account data manually entered by a merchant/clerk at the POS terminal. Further, as will be described later, in some embodiments of the invention, a pre-designated account associated with other existing infrastructure (such as credit card processing systems and loyalty card processing systems) could also be used to initiate the mobile device transaction.

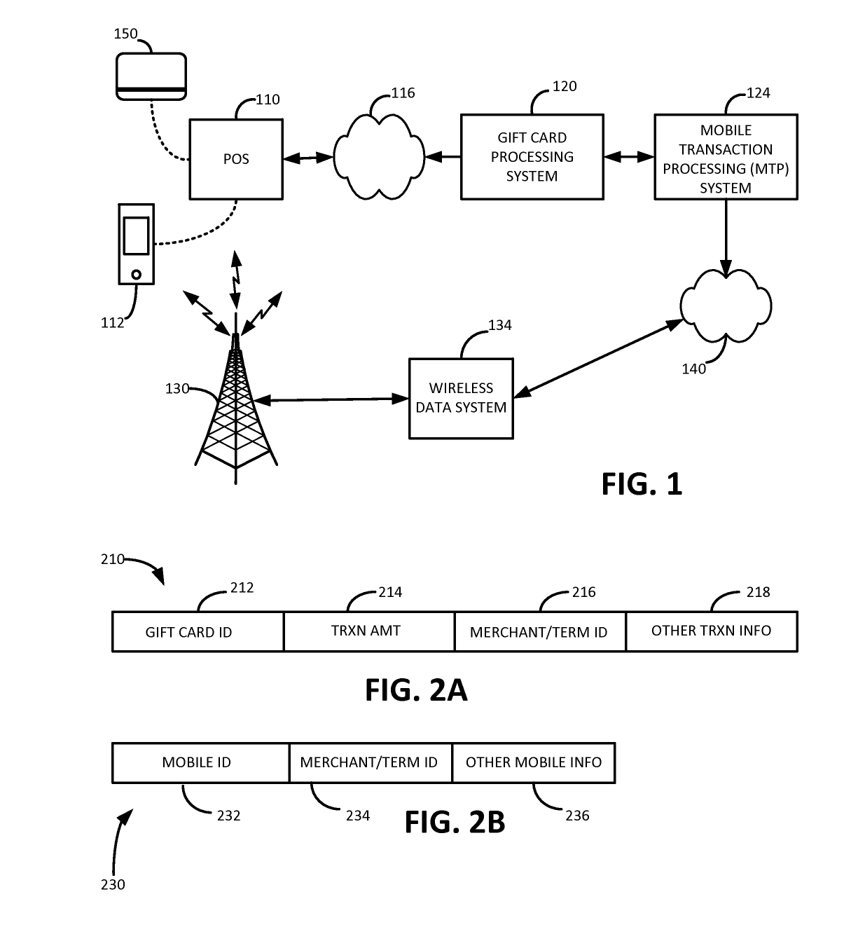

Turning now to FIG. 1, there is illustrated an embodiment of the invention, in which a merchant is enabled to conduct mobile device transactions using existing infrastructure to process such transactions. In particular, FIG. 1 illustrates a merchant POS terminal 110 for conducting transactions with a customer having a mobile device 112 (e.g., a smart phone). The POS terminal 110 is connected by way of a network 116 to a gift card processing system 120.

The network 116 may be, in whole or in part, a private (dedicated) network and/or a public network, such as the Internet. The gift card processing system 120 is connected in turn to a mobile transaction processing (MTP) system 124. The mobile device 112 communicates wirelessly through a wireless/cellular transmission communication system 130 which receives and transmits messages to various mobile devices. Those messages are handled by a wireless data system 134, usually operated by the same entity operating the communication system 130. Thus, the wireless data system 134 may be a standard data communications system that carries data messages (as opposed to voice calls) to and from the mobile device 110. The data messages may, for example, be encrypted and thus securely carried over the Internet. The wireless data system 134 is connected by way of a network 140 to the mobile transaction processing system 124. The network 140 may be, in whole or in part, a private (dedicated) network and/or a public network, such as the Internet.

Also illustrated in FIG. 1 is a gift card 150 that is used, in a manner to be described shortly, to facilitate mobile device transactions conducted between the consumer using the mobile device 112 and the merchant operating the POS device 110. The gift card 150 may be physically attached to the POS terminal 110 (such as being tethered with a cord, not illustrated), so the gift card 150 is available any time a clerk at the POS terminal desires to initiate a mobile device transaction with a customer. A gift card account number associated with the gift card 150 may be the same account number used by many different terminals since, as will be described shortly, its purpose is merely to indicate, when the transaction is processed through gift card infrastructure, that a mobile transaction rather than a gift card transaction is being conducted.

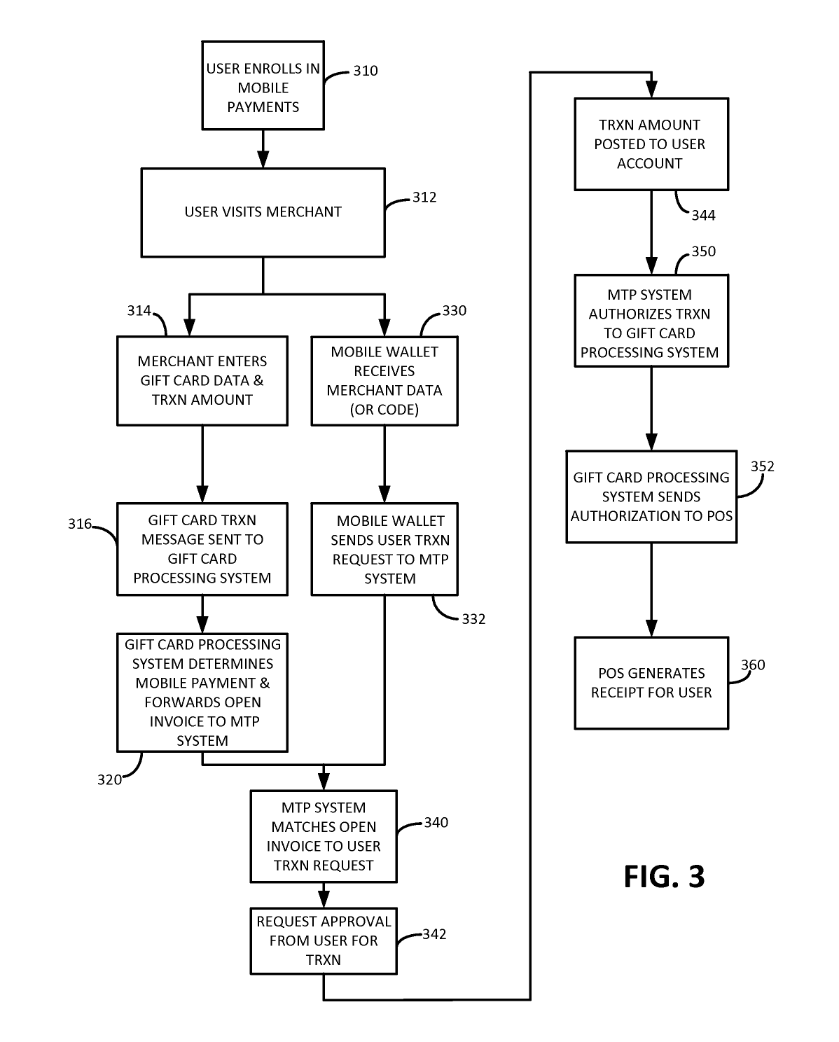

Generally, in the described embodiment, and as will be more fully described later in conjunction with FIG. 3, when a consumer desires to use his or her mobile device 112 to conduct a transaction at the POS terminal 110, the customer uses the mobile device 112 to scan an enabling code (such as a QR code) displayed at the POS terminal 112. The QR code identifies the POS terminal 110 and (when received at a mobile wallet application within the mobile device 112) causes the mobile device 112 to generate a message through the communication system 130, wireless data system 134 and network 140 to the mobile transaction processing system 124. That mobile device message identifies the POS terminal 110 and serves as a request to the mobile transaction processing system 124 to process a mobile device transaction. At about the same time, the POS terminal 110 initiates a message as well, identifying a transaction that is being conducted with a mobile device, such as the mobile device 112. The transaction at the POS terminal 110 is facilitated with the use of the gift card 150 that is used by a merchant employee when a mobile transaction is to be initiated, such as by swiping the gift card 150 at a card reader. As will be understood from a more detailed description below, the gift card 150 includes a per-designated or assigned gift card account number that is read by the POS terminal 110, which determines (based on the account number) that it is associated with a gift card and that the transaction should be sent to the gift card processing system 120 (as if it were a real gift card transaction) for processing and approval (rather than, say, to a credit card processing system). When the pre-designated gift card number is passed to the gift card processing system 120, it is recognized as a number that designates the transaction for mobile transaction processing (i.e., being used for a mobile device transaction rather than a gift card transaction). Transaction data associated with the mobile device transaction (terminal/merchant ID, transaction amount) is also provided with the gift card account number to the gift card processing system 120. The gift card processing system 120 (recognizing the gift card number as being used by a merchant to conduct a mobile device transaction) passes transaction data to the mobile transaction processing system 124, as an open invoice message for the transaction, with the mobile transaction processing system 124 matching the open invoice message to a transaction request received from the mobile device 112 in order to process the transaction.

FIGS. 2A and 2B generally illustrate messages that result from the swiping of the gift card 150 at the POS terminal 110 and the reading of a QR code (displayed at the POS terminal 110) by the mobile device 12.

In FIG. 2A, a message 210 is created at the POS terminal 110 when a gift card is entered (e.g., swiped at a card reader). The message includes the gift card ID or account number 212, a transaction amount 214 (e.g., entered by the clerk at the POS terminal for the particular item being purchased by the customer), a merchant/terminal ID 216 that identifies the merchant or the merchant terminal where the transaction is being conducted, and other transaction information that may be useful in completing the transaction (e.g., the date of the transaction, an ID for the clerk or employee conducting the transaction, identified promotions and discounts that may be associated with the transaction, and so forth). In FIG. 2B, a message 230 is created at a mobile wallet application resident at the mobile device 112, in response to reading/scanning by the mobile device 112 of a QR code located at the POS terminal 110. Message 230 includes a mobile ID 232 identifying the mobile device 112, a merchant/terminal ID 234, and other mobile transaction information 236 that might be useful for purposes of identifying the mobile device user wanting to conduct the transaction (e.g., the date/time that the QR code is scanned, a user password, etc.).

It should be appreciated that the message format seen in FIGS. 2A and 2B are only exemplary for purposes of facilitating an understanding of the invention and that, in various embodiments, the particular data may be different than that illustrated. For example, in one implementation, a reference number/identifier associated with a QR code may be included in message 230 rather than an actual merchant/terminal ID. In such implementation, a lookup table at the mobile transaction processing system 124 may be used to identify the merchant or terminal based on the reference number/identifier associated with the QR code that is located/displayed at to the POS terminal 110.

As will be described in greater detail shortly, the information in both messages 210 and 230 is ultimately received at the mobile transaction processing system 124 and compared, in order to link messages (from the mobile device 112 and the POS terminal 110) that are associated with the same transaction being conducted by the customer at the POS terminal 110. For purposes of linking messages and processing a transaction, the messages 210 and 230 include at least information used by mobile transaction processing system 124 to identify the messages as related to the same transaction, such as information that identifies the merchant/terminal where the transaction is being conducted.

Turning now to FIG. 3, there is illustrated in greater detail a process for completing a mobile device transaction at the POS terminal 110 seen in FIG. 1. Prior to conducting a transaction, a user of a mobile device first enrolls (step 310) the mobile device for conducting transactions, such as by visiting a website for such purpose and downloading a mobile wallet application. Among other things, the enrollment includes linking or associating financial accounts of the user with a mobile device (e.g., at the mobile application resident on the device), with such accounts to be used when conducting transactions at a merchant that has agreed to accept such transactions. At step 312, the user visits a merchant and decides to make a purchase using his/her mobile device 112 at the POS terminal 110. At step 314, the merchant enters gift card account data that has been provided at the POS terminal 110 and also enters a transaction amount. As mentioned earlier, the gift card account data may be stored/embedded in a gift card (such as the gift card 150 seen in FIG. 1), such as one tethered to the POS terminal 110 (as described earlier) or that may be carried by a clerk to be used anytime a customer desires to conduct a mobile device transaction. The clerk would have been trained in advance to use the gift card anytime a customer desires to conduct a mobile device transaction. Further, other data concerning the desired transaction may also be entered at the POS terminal 110, such as the transaction and merchant ID data illustrated in FIG. 2A.

The data entered at step 314 is treated by the POS terminal 110 as a gift card transaction and is sent to the gift card processing system 120 to be processed, step 316. The gift card processing system 120 recognizes the gift card number as one that has been designated for use with mobile transactions, and thus uses the data from the POS terminal to create an open invoice message (identifying the transaction using the same transaction data and indicating that a mobile transaction is desired), and sends the open invoice message to the mobile transaction processing system 124, at step 320.

At about the same time or nearly simultaneously with steps 314, 316 and 320, the customer at the POS terminal 110 scans the QR code located at the POS terminal 110, step 330. An application resident at the mobile device 112 (such as an application that is loaded onto the mobile device 112 when a user enrolls at step 310) uses data associated with the QR code to generate a message, such as the message 230 seen in FIG. 2B, and sends that message (step 332) as a transaction request (through the communication system 130, wireless data system 134 and network 140) to the mobile transaction processing system 124.

It should be appreciated, alternative processes could be employed to capture an enabling code at the mobile device 112 data, such as the transmission of an enabling code by way of NFC or Bluetooth communications from the POS terminal 110 to the mobile device 112 (such as when the mobile device is put into close proximity to the POS terminal 110, and the user of the mobile device then requesting the enabling code).

As should also be appreciated, at any given time, the mobile transaction processing system 124 may be receiving multiple open invoice messages (from various point-of-sale terminals where customers are attempting to conduct transactions) and multiple transaction request messages originating from various users of mobile devices 112. At step 340, the mobile transaction processing system 124 matches an open invoice message and any transaction request that originated at the same POS terminal 110 (for example, by determining that such messages have originated from the same merchant/terminal at about the same time). When two such messages are matched, the mobile transaction processing system 124 returns a message to the mobile device 112 (through network 140, wireless data system 134 and communication system 130), requesting that the user of the mobile device approve the transaction, step 342. For example, in response to an approval request from the mobile transaction processing system, the mobile wallet application resident at the mobile device 112 may ask the user (via the user interface/display at the mobile device) to approve a transaction for a specified amount that has been entered at the POS terminal 110, and further ask the user which of the user accounts (if more than one has been enrolled) that the user would like to use for conducting the transaction.

If the user approves the transaction, then the transaction amount is posted to the selected account at step 344 (such as by the mobile transaction processing system sending an electronic debit request to the appropriate bank maintaining the account), and the mobile transaction processing system 124 authorizes the transaction to the gift card processing system 120 (step 350). The gift card processing system 120 in turn sends the authorization through network 116 back to the POS terminal 110 (step 352), where, in a manner similar to a standard gift transaction, a message may be displayed at the POS terminal 110 approving the transaction and the clerk at the POS terminal 110 is able to print a receipt for the customer and complete the sale, step 360. It should be appreciated that the authorization message to the POS terminal 110 may include information (originating in the communications from mobile transaction processing system 124 to gift card processing system 120) that could be used in printing the receipt, including the amount of the transaction and an identifier (e.g., the last 4 digits) of the account number of the user's account that has been debited.

Although not illustrated in FIG. 3, it should be appreciated that, in some cases, various discounts or promotions may be associated with the transaction. As an example, a merchant may promote the use of a mobile device at the POS terminal 110, such as by a display encouraging customers to use their mobile device and offering a coupon, discount or some other promotional item for any user that conducts such a transaction. When a mobile transaction is recognized and approved at the mobile transaction processing system 124, the authorization message back to the POS terminal 110 may include data that discounts the transaction (if a discount has been offered) or data that can be used to print a coupon with the receipt provided to the customer at step 360. Such an arrangement not only benefits the customer, but may also benefit the merchant by promoting use of a mobile device for conveniently conducting transactions without the merchant having to make expensive changes/updates to its systems in order to process such transactions.

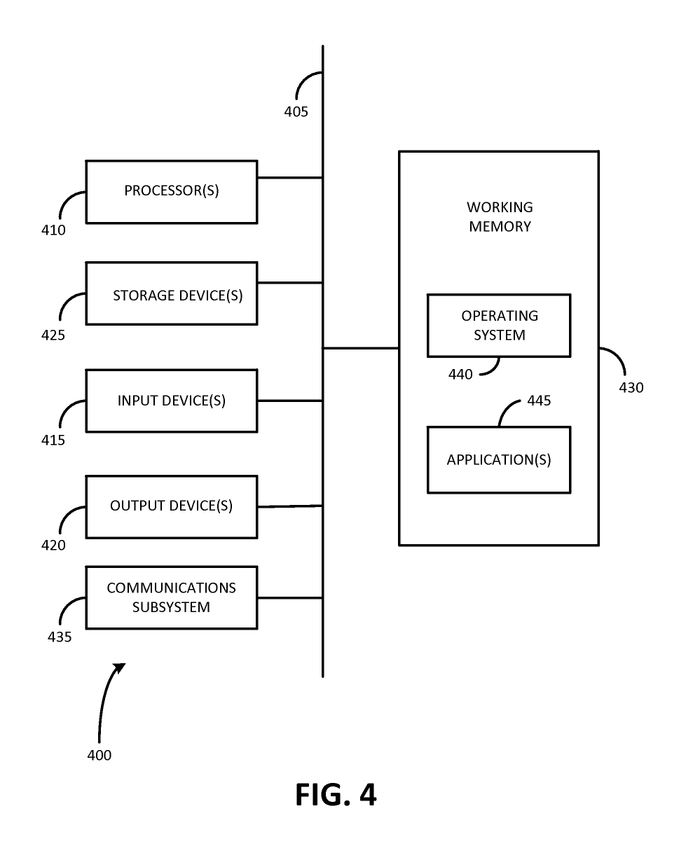

FIG. 4 is a block diagram illustrating an exemplary computer system upon which embodiments of the present invention may be implemented. This example illustrates a computer system 400 such as may be used, in whole, in part, or with various modifications, to provide the computing/processing functions of the POS terminal 110, mobile device 112, gift card processing system 120 and mobile transaction processing system 124, as well as other components and functions of the invention described herein.

The computer system 400 is shown comprising hardware elements that can be electrically coupled or otherwise in communication via a bus 405. The hardware elements can include one or more processors 410, including, without limitation, one or more general-purpose processors and/or one or more special-purpose processors (such as digital signal processing chips, graphics acceleration chips, and/or the like), one or more input devices 415 (which can include, without limitation, a mouse, a keyboard and/or the like), and one or more output devices 420, which can include, without limitation, a display device, a printer and/or the like.

The computer system 400 may further include one or more storage devices 425, which can comprise, without limitation, local and/or network accessible storage or memory systems having computer or machine readable media. Common forms of physical and/or tangible computer readable media include, as examples, a floppy disk, a flexible disk, hard disk, magnetic tape, or any other magnetic medium, an optical medium (such as CD-ROM), punchcards, papertape, any other physical medium with patterns of holes, a random access memory (RAM), a read only memory (ROM) which can be programmable or flash-updateable or the like, and any other memory chip, cartridge, or medium from which a computer can read data, instructions and/or code. In many embodiments, the computer system 400 will further comprise a working memory 430, which could include (but is not limited to) a RAM or ROM device, as described above.

The computer system 400 also may further include a communications subsystem 435, such as (without limitation) a modem, a network card (wireless or wired), an infra-red communication device, or a wireless communication device and/or chipset, such as a Bluetooth® device, an 802.11 device, a WiFi device, a WiMax device, a near field communications (NFC) device, cellular communication facilities, etc. The communications subsystem 435 may permit data to be exchanged with a network, and/or any other devices described herein. Transmission media used by communications subsystem 435 (and the bus 405) may include copper wire, coaxial cables and fiber optics. Hence, transmission media can also take the form of waves (including, without limitation radio, acoustic and/or light waves, such as those generated during radio-wave and infra-red data communications).

The computer system 400 can also comprise software elements, illustrated within the working memory 430, including an operating system 440 and/or other code, such as one or more application programs 445, which may be designed to implement, as an example, various portions of the process seen in FIG. 3.

As an example, one or more methods discussed earlier might be implemented as code and/or instructions executable by a computer (and/or a processor within a computer). In some cases, a set of these instructions and/or code might be stored on a computer readable storage medium that is part of the system 400, such as the storage device(s) 425. In other embodiments, the storage medium might be separate from a computer system (e.g., a removable medium, such as a compact disc, etc.), and/or provided in an installation package with the instructions/code stored thereon. These instructions might take the form of code which is executable by the computer system 400 and/or might take the form of source and/or installable code, which is compiled and/or installed on the computer system 400 (e.g., using any of a variety of generally available compilers, installation programs, compression/decompression utilities, etc.). The communications subsystem 435 (and/or components thereof) generally will receive the signals (and/or the data, instructions, etc., carried by the signals), and the bus 405 then might carry those signals to the working memory 430, from which the processor(s) 405 retrieves and executes the instructions. The instructions received by the working memory 430 may optionally be stored on storage device 425 either before or after execution by the processor(s) 410.

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention. As one example, the gift card processing system 120 and mobile transaction processing system 124 may each be implemented by a single system having one or more storage device and processing elements. As another example, the gift card processing system 120 and mobile transaction processing system 124 may each be implemented by plural systems, with their respective functions distributed across different systems either in one location or across a plurality of linked locations.

Moreover, while the various flows and processes described herein (e.g., those illustrated in FIG. 3) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method for processing a transaction conducted at a point-of-sale (POS) terminal using a mobile device, comprising:
receiving, at a mobile transaction processing system, an open invoice message generated by a card processing system, wherein the card processing system generates the open invoice message in response to a card identifier that is received in connection with a mobile device transaction and that has been pre-designated for use with mobile transactions at a POS terminal;
receiving, at the mobile transaction processing system, a mobile transaction request generated by a user of a mobile device at the POS terminal, wherein the mobile transaction request is generated in response to receiving an enabling code at the mobile device, wherein the enabling code is received at the mobile device upon a user initiating a transaction at the POS terminal;
determining, at the mobile transaction processing system and based upon the open invoice message and the mobile transaction request, that the received open invoice message and the received mobile transaction request are for the same mobile device transaction; and
in response to determining that the open invoice message and the transaction request are for the same mobile device transaction, processing that mobile device transaction at the mobile transaction processing system.

2. The method of claim 1, wherein the open invoice message comprises transaction information including at least identifying data that identifies the POS terminal, and wherein the transaction request includes identifying data that identifies at least the mobile device and the POS terminal.

3. The method of claim 1, wherein the card identifier is a gift card account number.

4. The method of claim 3, wherein the gift account number is read from a gift card that is located at the POS terminal and used for any transaction at the POS terminal that is a mobile device transaction.

5. The method of claim 4, wherein the gift card is physically attached to the POS terminal.

6. The method of claim 1, wherein the card identifier is a credit card account number.

7. The method of claim 1, wherein the card identifier is a loyalty card account number.

8. The method of claim 1, wherein the enabling code comprises a QR code located at the POS terminal.

9. The method of claim 1, wherein the enabling code is provided to the mobile device from the POS terminal through NFC or Bluetooth communications.

10. The method of claim 1 wherein, in response to determining that the open invoice message and receive mobile transaction request are for the same transaction, requesting by the mobile transaction processing system authorization of the transaction from the mobile device.

11. The method of claim 10, wherein, in response to receiving the authorization of the transaction from the mobile device, the mobile device transaction processing system processes a transaction amount against an account of the user of the mobile device.

12. The method of claim 10, where in response to receiving the authorization of the transaction from the mobile device, the mobile device transaction processing system sends an authorization message through the card processing system to the POS terminal.

13. A card account number method for processing a transaction at a point-of-sale (POS) terminal using a customer mobile device, comprising:
receiving, at a mobile wallet application resident at the customer mobile device, data representing a merchant ID associated with a POS terminal, the mobile wallet application having an associated account for use in conducting a mobile transaction;
sending a transaction request from the mobile wallet application to a mobile transaction processing system, the message including the merchant ID;
receiving, a the POS terminal, a nominal gift card account ID, the gift card account ID entered at the POS terminal when a customer intends to use the account associated with the mobile wallet application for conducting the transaction with the merchant;
a gift card transaction processing system for conducting gift card transactions at the merchant POS terminal, the card transaction processing system recognizing the nominal gift card account ID as having been received at the POS terminal for purposes of conducting a transaction with an account associated with the mobile wallet application, the card transaction processing system generating an open invoice message to notify a mobile transaction processing system of receipt of the nominal gift card account ID along with information associated with the transaction;
comparing, at the mobile transaction process system, the transaction request from the mobile wallet application to the open invoice message; and
when the transaction request and the open invoice message are matched at the mobile transaction processing system as having come from the POS terminal, requesting, from the mobile transaction processing system, that the customer approve the transaction.

14. A mobile transaction processing system for processing a transaction conducted at a point-of-sale (POS) terminal using a mobile device, comprising:
a processor; and
a memory, the memory storing instructions that are executable by the processor and configure the mobile transaction processing system to:
receive, at a mobile transaction processing system, an open invoice message generated by a card processing system, wherein the card processing system generates the open invoice message in response to a card identifier that is received in connection with a mobile device transaction and that has been pre-designated for use with mobile transactions at a POS terminal;
receive, at the mobile transaction processing system, a mobile transaction request generated by a user of a mobile device at the POS terminal, wherein the mobile transaction request is generated in response to receiving an enabling code at the mobile device, wherein the enabling code is received at the mobile device upon a user initiating a transaction at the POS terminal; and
determine, at the mobile transaction processing system and based upon the open invoice message and the mobile transaction request, that the received open invoice message and the received mobile transaction request are for the same mobile device transaction; and
in response to determining that the open invoice message and the transaction request are for the same mobile device transaction, process that mobile device transaction at the mobile transaction processing system.

15. The system of claim 14, wherein the open invoice message comprises transaction information including at least identifying data that identifies the POS terminal, and wherein the transaction request includes identifying data that identifies at least the mobile device and the POS terminal.

16. The system of claim 14, wherein the card identifier is a gift card account number.

17. The system of claim 16, wherein the gift account number is read from a gift card that is located at the POS terminal and used for any transaction at the POS terminal that is a mobile device transaction.

18. The system of claim 17, wherein the gift card is physically attached to the POS terminal.

19. The system of claim 14, wherein the card identifier is a credit card account number.

20. The system of claim 14, wherein the card identifier is a loyalty card account number.

21. The system of claim 14, wherein the enabling code comprises a QR code located at the POS terminal.

22. The system of claim 1, wherein the enabling code is provided to the mobile device from the POS terminal through NFC or Bluetooth communications.

23. The system of claim 14 wherein, in response to determining that the open invoice message and receive mobile transaction request are for the same transaction, requesting by the mobile transaction processing system authorization of the transaction from the mobile device.

24. The system of claim 23, wherein, in response to receiving the authorization of the transaction from the mobile device, the mobile device transaction processing system processes a transaction amount against an account of the user of the mobile device.

25. The system of claim 23, wherein, in response to receiving the authorization of the transaction from the mobile device, the mobile device transaction processing system sends an authorization message through the card processing system to the POS terminal.
